(19) United States
(12) Patent Application Publication
(10) Pub. No.: US 2016/0326428 A1
(43) Pub. Date: Nov. 10, 2016

(54) Resin Coated Proppants and Process for the Preparation Thereof

(71) Applicant: COUNCIL OF SCIENTIFIC & INDUSTRIAL RESEARCH, New Delhi (IN)

(72) Inventors: Dipak Kumar Dutta, Johart (IN); Pinaki Sengupta, Johart (IN); Kokil Saikia, Johart (IN); Podma Pollov Sarmah, Johart (IN); Ankana Phukan, Johart (IN)

(21) Appl. No.: 15/109,147

(22) PCT Filed: Dec. 24, 2014
(86) PCT No.: PCT/IN2014/000798

§ 371 Date: Jun. 30, 2016

(30) Foreign Application Priority Data
Dec. 30, 2013 (IN) 3807/DEL/2013

(51) Int. Cl. C09K 8/80; C04B 35/626; C04B 35/111

(52) U.S. Cl. CPC C09K 8/805; C04B 35/1115; C04B 35/62695; C04B 2235/6567; C04B 2235/96; C04B 2235/9692

(57) ABSTRACT

The present invention provides a process for preparing resin coated highly spherical proppants of sizes 12/20 and 20/40 US mesh by sintering the calcined bauxite and then coating with resol type phenolic resin comprising phenol, m-cresol and formaldehyde. Coating is done without using any coupling or partitioning agent. The resin coated proppants prepared by the method of the present invention are useful in hydraulic fracturing of oil and gas producing formations. The prepared proppants have high acid resistance towards 3% HF-12% HCl mixture and have high crush resistance (upto 15000 psi) as per API specifications.

### FIELD OF THE INVENTION

The present invention relates to resin coated proppants useful in hydraulic fracturing of oil and gas producing formations. The present invention also relates to a process for the preparation of resin coated proppants. The present invention further relates to a process for the production of resin coated sintered bauxite proppants having high acid resistance towards 3% HF-12% HCl mixture.

### BACKGROUND OF THE INVENTION

Oil and Natural Gas are produced from wells having porous and permeable subterranean formations. The porosity of the formation permits the formation to store oil and gas, and then the permeability of the formation allows oil and gas to flow through the formation. Permeability of the formation is essential to allow oil and gas to flow to a location where it can be produced from the well. In some oil and gas bearing formations, the permeability is not sufficient enough for economic recovery of oil and gas. Sometimes, during production from the well, the permeability of the formation drops to the extent that further recovery becomes uneconomical. In such cases, it is essential to fracture the formation and prop the fracture open by means of a proppant material or propping agent. Fracturing is accomplished by pumping a fracturing fluid containing proppants at a high pressure down the well bore to overcome the tensile strength of the formation and the weight of overburden to rupture the formation and create fractures. The proppants are deposited in the fractures which prevent closing of fractures when pressure on the fracturing liquid is released. Thus, the proppants, when properly placed, provide high permeability in the fracture.

A variety of particulate materials are used as proppants. Silica sand is the most widely used commercial propping agent for shallow wells because of its cheapness and ease of availability. The choice of proppants depends largely upon the formation pressure. At closure stresses encountered in deep formations, sand proppants tend to disintegrate, producing fines which reduce the permeability of the propped fracture.

References may be made to Journal, “Sinclair et.al., SPE 11579, 1983” wherein glass beads, steel shots, resin coated sand etc. were developed. But in deep wells where high pressures are encountered, these propping agents are either entirely ineffective or do not exhibit desired permeability.

References may be made to US Patent 4427068, wherein the patent discloses manufacture of sintered spherical pellets from calcined bauxite, calcined clay, calcined alumina or mixture thereof. The average particle size of the raw mix is preferably less than about 5 micron. Such proppants as per the disclosure, are aptly suited for use under a formation pressure upto about 10,000 psi. Fitzgibbon in his another U.S. Pat. No. 4,623,630 discloses the manufacturing process for a composite sintered spherical pellets using calcined and partially calcined or uncalcined ingredients like diaspore clay. The patent discloses that the starting ingredients contain particles of average size less than 5 micron. These proppants are suitable upto a pressure of 10000 psi.

References may be made to U.S. Pat. No. 4,713,203, wherein the patent discloses a process for making sintered bauxite proppants from very fine powder of size 0.02 to 0.3 micron. Such pellets show high permeability at pressure upto 20000 psi.

References may be made to U.S. Pat. No. 4,869,960, wherein patent discloses spheroidal ceramics coated with novolac epoxy resin for use in hydraulic fracturing. According to the patent, fired ceramic spheroids are mixed with a silane coupling agent prior to the coating with epoxy resin.

References may be made to U.S. Pat. No. 5,921,317, wherein the patent discloses coating of well proppant with hardenable resin-fibre composites. The patent also discloses the use of aminosilane compounds as a coupling agent. Preferred fibrous material used for resin-composition is cellulose acetate.

References may be made to U.S. Pat. No. 7,135,231, wherein patent discloses a process for coating particles in an incremental manner wherein the final product has multiple resin partial coats interleafed together into micro layers. Hexamethylenetetraamine (HMTA) was used as the preferred curing agent. In addition, reinforcing agent was used during the resin coating process. Thus, overall process of making the coating of proppants involves cumbersome process parameters as well as multi components system.

References may be made to U.S. Pat. No. 7,883,740, wherein patent discloses a process for making low quality particles with crush resistance test up to a stress level of 5,000 psi only, while proppants of higher quality need to withstand a stress level up to 15,000 psi as per API recommendations. Moreover, the process involved two layers resin coating of proppants. Therefore, the process stands for preparing low quality proppants only.

References may be made to U.S. Pat. 6,582,819, wherein patent discloses methods of making and using low density composite proppant. The composite material comprises a low density filler material (such as ground walnut shells) together with a higher density filler material (such as finely divided silica), and a binder of polymer resin and cement.

References may be made to US Application 2006/0284346, wherein patent discloses resin coated sand produced by coating the surface of a refractory granular aggregate with a thermosetting resin and a thermoplastic resin. Different resins were used which included the phenolic resin.

References may be made to US Application 2008/0274374, wherein the application discloses resin-coated containing spherical molding sand with a binder composition, the spherical molding sand having an average particle diameter of 0.02 to 1.5 mm and being produced by a flame fusion method. The binder composition used in the invention contains a resin and can contain a disintegration accelerator, a lubricant, a silane coupling agent, a curing agent etc. if necessary.

References may be made to U.S. Pat. No. 7,350,571, wherein patent discloses methods of preparing and using coated particulates, using bauxite as raw material. The particulates were coated by different resins using different hardening and partitioning agents. These coated particulates need a couple of weeks before getting ready for use. In addition, the crush resistance of the coated particulates was tested upto 1,100 psi only; whereas in practice much more drastic conditions are required to be tested at.

Although all the prior art mentioned above provide various methods or processes for preparing different types of proppants, search for improved quality proppants still persists. One main problem often encountered during hydraulic fracturing is the acid solubility of the proppants. One major component of the fluid used during fracturing is the acid mixture of 3% HF-12% HCl. Quality of the proppants can thus be improved in terms of acid solubility if coated with a suitable resin. Moreover, mechanical strength of the proppants can also be improved by a resin coating. As the well holes extend deep into the horizon, mechanical strength of proppants is an important aspect to consider.

### OBJECTIVES OF THE INVENTION

The main objective of the present invention is to provide a resin coated proppants which can withstand maximum mechanical strength as per API specification for hydraulic fracturing.

Another objective of the present invention is to provide a process for the preparation of resin coated proppants in order to increase the acid resistance towards 3% HF-12% HCl acid mixture.

Yet another objective of the present invention is to coat sintered bauxite proppants by a suitable resin to improve the acid solubility of proppants.

Still another objective of the present invention is to further improve the mechanical strength of sintered bauxite proppants by coating with suitable a resin.

Still another objective of the present invention is to provide preparation of spherical proppants from calcined bauxite samples having different alumina content. Still another objective of the present invention is to provide a method of coating spherical proppants with a phenolic resin.

Still another objective of the present invention is to provide a process of coating spherical sintered bauxite proppants with resol type phenol-m-cresol-formaldehyde resin.

### SUMMARY OF THE INVENTION

Accordingly, present invention provides a resin coated proppant comprising a resin in the amount of 1.5 to 2% by weight; and a proppant in the amount of 98% to 98.5% by weight, wherein the resin is phenol-m-cresol-formaldehyde resin and the proppant is bauxite and the resin is coated over the proppant, wherein said resin coated proppant exhibits resistance in the range of 13.7 to 40.96% by weight against 3% HF-12% HCl mixture and resistance in the range of 26.93 to 69.26% by weight against pressure in the range of 7500 to 15000 psi.

In an embodiment of the present invention, there is provided a process for the preparation of resin coated proppant, the process comprising the steps of:
i. grinding raw calcined bauxite to obtain ground bauxite particles having particle size in the range of 50 to 100 microns;
ii. pelletizing the ground bauxite particles obtained in step (i) in a pelletizing machine by adding 5 to 10% water with the ground bauxite particles and rotating the machine for a period in the range of 5 to 15 min to obtain pellets;
iii. sieving the pellets obtained in step (ii) to separate pellets having size in the range of 425 to 850 micron;
iv. air drying the separated pellets obtained in step (iii) for a period in the range of 24 to 36 hours to obtain dried pellets;
v. sintering the dried pellets obtained in step (iv) at temperature in the range of 1350 to 1450° C. for a period in the range of 30 to 35 minutes to obtain proppants;
vi. dissolving 5 to 10% of a resin in a solvent to obtain a resin solution;
vii. pouring the resin solution obtained in step (vi) on the proppants obtained in step (v) in a ratio ranging between 1:40 to 1:60 (w/w) with stirring for a period in the range of 30 to 35 minutes at a temperature in the range of 40 to 50° C. followed by drying and heating at a temperature in the range of 60 to 100° C. to obtain the resin coated proppants.

In another embodiment of the present invention, there is provided a process for the preparation of resin coated proppant, wherein the resin is phenol-m-cresol-formaldehyde resin.

In yet another embodiment of the present invention, there is provided a process for the preparation of resin coated proppant, wherein the resin comprises phenol, m-cresol and formaldehyde in the molar ratio in the range of 1:1:1.5 to 1:1:2.

In yet another embodiment of the present invention there is provided a process for the preparation of resin coated proppant, wherein the solvent is acetone.

### DETAIL DESCRIPTION OF THE INVENTION

The present invention is directed towards a resin coated proppant exhibiting acid resistance against 3% HF-12% HCl mixture. The present invention also provides a process for the preparation of resin coated proppants by coating sintered proppants with a suitable phenolic resin in order to reduce the acid solubility and to increase the mechanical strength.

More particularly, the present invention relates to a method of coating sintered bauxite proppants without using any coupling and partitioning agent.

Proppants prepared from bauxite (about 80% alumina) can be used for hydraulic fracturing of oil and natural gas producing formations. Proppants prepared from sintered bauxite are evaluated as per American Petroleum Institute recommendations

[API, Recommended Practices 60 (RP 60), for testing high strength proppants used in hydraulic fracturing Operation; 2nd Edition, Feb. 1, 1995]. The present invention provides an improved quality of resin coated proppants over uncoated proppants. The resin coating reduces the acid solubility upto 40% (Table 1), and at the same time enhances the crush resistance strength by 27-70% (Table 2) upto a pressure of 15,000 psi fulfilling the API specification.

In the present invention, proppants are prepared by using calcined bauxite as a raw material. The raw calcined bauxite is ground to particles having size below 100 micron, preferably around 50 micron using iron ball mill. Pelletization of the ground bauxite is done to obtain pellets with desired size, high sphericity and roundness. Two-step pelletization process has been adopted to prepare the green pellets having desired characteristics. In the first step, green pellets of desired size are prepared in a pelletizing machine (Eirich Transweigh Lab Mixer RV02) and in the second step, the pellets are rolled over a rotating pan of the Mixer to obtain smoother surface of the pellets. Pellets are then sieved into two sizes i.e. 12/20 and 20/40 US mesh. Green pellets contain considerable amount of free water, which is required to be removed by air drying before sintering. The dried green pellets are then sintered at a temperature in the range 1350-1450° C. depending upon the composition, for 30 minutes. Sintering essentially removes pores between the starting particles, accompanied by shrinkage and strong bonding between adjacent particles.

The sintered proppants are then subjected to different physico-chemical tests as per API specifications. Important tests required to fulfill by these proppants are the acid solubility test in 3% HF-12% HCl acid mixture and crush resistance test upto 15000 psi.

Sintered proppants are then coated by a resol type phenolic resin prepared from phenol-m-cresol-formaldehyde resin. The resin is prepared by refluxing a mixture of phenol, m-cresol and formaldehyde in the molar ratio of 1:1:2 at 100° C. in an aqueous medium. The reaction is carried out for 10-12 hours at pH 9-10. The brown oily product is separated by decantation followed by dehydration under reduced pressure.

The process for coating of proppants with resin is carried out as following:

A solution of phenolic resin in acetone prepared by dissolving 1 g resin in minimum volume of acetone is poured on 50 gms of proppants followed by constant stirring for about 30 minute at about 45° C. The sintered proppants are dried followed by heating in an oven at a temperature range 60-100° C.

Coated proppants are then subjected to the acid solubility and the crush resistance test as per the API specifications. The result of the acid solubility test is provided in Table 1 and the results of crush resistance test is provided in Table 2.

TABLE 1
Results of acid solubility test^{a}

| | Acid solubility (in % w/w) | | % of |
|---|---|---|---|
| Size of proppants | Before | After coating | improvement |
| (US mesh) | coating | with resin | after coating |
| 12/20 | 4.73 | 4.08 | 13.7 |
| 20/40 | 8.08 | 4.77 | 40.96 |

^{a}Test conditions: 100 ml 3% HF-12% HCl mixture, 65 ± 1° C., 30 min, 5 g proppant.

TABLE 2
Results of crush resistance test^{a}

| | Size of proppant | | | Size of proppant | | |
|---|---|---|---|---|---|---|
| | 12/20 (US mesh) | | % of | 20/40 (US mesh) | | |
| | Fine generated | | improve- | Fine generated | | |
| Stress | (wt %) | | ment | (wt %) | | % of |
| level | Before | After | after | Before | After | improvement |
| (psi) | coating | coating | coating | coating | coating | after coating |
| 7500 | 4.27 | 3.12 | 26.93 | 5.4 | 2.2 | 59.25 |
| 10000 | 9.8 | 3.67 | 62.55 | 8.6 | 3.97 | 53.83 |
| 12500 | 11.5 | 4.74 | 58.78 | 13.2 | 4.35 | 67.04 |
| 15000 | 16.3 | 5.5 | 66.25 | 17.7 | 5.44 | 69.26 |

^{a}Test condition: 49.4499 g proppant, 1 min for rising the pressure, 1 min for sustaining the pressure.

### EXAMPLE

Following examples are given by way of illustration therefore should not construed to limit the scope of the invention.

### Example 1

Green pellets were prepared by mixing 4 kg bauxite powder containing 79.95% alumina with 0.5 liter water in a pelletizing machine. The impeller and the rotating pan of the machine were allowed to rotate for 3 minutes with continuous spray of water. After that, the rotation of the impeller was stopped and rotation of the rotating pan was continued for another 3 minutes at low speed for higher sphericity and roundness. Then the machine was turned off, pellets were discharged and sieved to obtain desired sizes i.e. 12/20 and 20/40 US mesh. Green pellets were then air dried for 24 hours followed by sintering at 1375° C. for 30 minutes. After that, the sintered proppants were subjected to acid solubility tests in 3% HF-12% HCl mixture at 65° C. as per the API specification. Proppants were kept in the acid mixture for 30 minutes and then filtered through a G-4 sintered crucible. Weight loss in % was calculated by taking the weight of the sintered proppants before and after the test. Weight loss due to acid solubility for 12/20 and 20/40 US mesh were obtained as 4.73% and 8.08%, respectively.

### Example 2

Proppants were prepared as per the procedure provided in Example 1. Sintered proppants were then subjected to crush resistance test as per the API specifications. Crush resistance tests were done at four different pressures i.e. 7500 psi, 10000 psi, 12500 psi and 15000 psi. During the test, the required pressure was attained in 1 minute and same pressure was maintained for another minute. Weight loss in terms of fine generated in wt % was calculated by screening the crushed proppants at different stress level with corresponding sieves. The result obtained is provided in Table 3.

TABLE 3
Results of crush resistance test

Size of proppant

| | 12/20 (US mesh) | 20/40 (US mesh) |
|---|---|---|
| Stress level | Fine generated (wt %) | Fine generated (wt %) |
| 7500 psi | 4.27 | 5.4 |
| 10000 psi | 9.8 | 8.6 |
| 12500 psi | 11.5 | 13.2 |
| 15000 psi | 16.3 | 17.7 |

### Example 3

Bauxite powder containing 80.35% alumina was taken and green pellets were prepared as per the procedure provided in Example 1. Green pellets were then sintered at 1425° C. Acid solubility tests and crush resistance tests were done as per Example 1 and Example 2, respectively. Weight loss due to acid solubility of proppants of size 12/20 and 20/40 US mesh are 8.87% and 10.73%, respectively. Weight loss in terms of fine generated in wt % was calculated by screening the crushed proppants at different stress levels with corresponding sieves. The result obtained is provided in Table 4.

TABLE 4
Results of crush resistance test

Size of proppant

| | 12/20 (US mesh) | 20/40 (US mesh) |
|---|---|---|
| Stress level | Fine generated (wt %) | Fine generated (wt %) |
| 7500 psi | 4.6 | 3.12 |
| 10000 psi | 7.46 | 3.6 |
| 12500 psi | 12.62 | 6.52 |
| 15000 psi | 15.43 | 12.66 |

### Example 4

Bauxite powder containing 47.91% alumina was taken and green pellets were prepared as per the procedure provided in Example 1. Green pellets were then sintered at 1400° C. Acid solubility tests and crush resistance tests were performed as per Example 1 and Example 2, respectively. Weight loss due to acid solubility of proppants of size 12/20 and 20/40 US mesh are 7.83 and 10.25%, respectively. Weight loss in terms of fine generated in wt % was calculated by screening the crushed proppants at different stress level with corresponding sieves. The result obtained is provided in Table 5.

TABLE 5
Results of crush resistance test

Size of proppant

| | 12/20 (US mesh) | 20/40 (US mesh) |
|---|---|---|
| Stress level | Fine generated (wt %) | Fine generated (wt %) |
| 7500 psi | 6.01 | 8.1 |
| 10000 psi | 12.2 | 8.6 |
| 12500 psi | 17.6 | 9.7 |
| 15000 psi | 25.5 | 18.4 |

### Example 5

Proppants are coated by a resol type phenolic resin prepared from phenol-m-cresol-formaldehyde in the molar ratio of 1:1:2). Proppants sintered at 1375° C. were taken and coating was done in a resin solution using acetone as the solvent. The resin and proppants were taken in a ratio 1:50 (w/w). The resin solution in acetone was poured into the mass of proppants and stirred for 30 minutes at about 45° C. to obtain the resin coated proppants.

Acid solubility test was conducted on the resin coated proppants as per the procedure provided in Example 1.Weight loss due to acid solubility of resin coated proppants of size 12/20 and 20/40 US mesh were obtained as 4.08 and 4.77%, respectively. Crush resistance test were also conducted for the resin coated proppants as per the procedure provided in Example 2.Weight loss in terms of fine generated in wt % due to crushing of the resin coated proppants of size 12/20 and 20/40 US mesh are as provided in Table 6.

TABLE 6
Results of crush resistance test

Size of proppant

| | 12/20 (US mesh) | 20/40 (US mesh) |
|---|---|---|
| Stress level | Fine generated (wt %) | Fine generated (wt %) |
| 7500 psi | 3.12 | 2.2 |
| 10000 psi | 3.67 | 3.97 |
| 12500 psi | 4.74 | 4.35 |
| 15000 psi | 5.5 | 5.44 |

### Example 6

Proppants sintered at 1425° C. were taken and coating was done with resol type phenolic resin in the similar procedure as provided in Example 5. Weight loss due to acid solubility of resin coated proppants of size 12/20 and 20/40 US mesh were obtained as 4.11 and 4.33%, respectively. Crush resistance test were also conducted for the resin coated proppants as per the procedure provided in Example 2. Weight loss in terms of fine generated in wt % due to crushing of the resin coated proppants of size 12/20 and 20/40 US mesh are as provided in Table 7.

TABLE 7
Results of crush resistance test

Size of proppant

| | 12/20 (US mesh) | 20/40 (US mesh) |
|---|---|---|
| Stress level | Fine generated (wt %) | Fine generated (wt %) |
| 7500 psi | 3.71 | 3.24 |
| 10000 psi | 3.84 | 3.62 |
| 12500 psi | 4.93 | 4.21 |
| 15000 psi | 6.47 | 6.42 |

### Example 7

Proppants sintered at 1400° C. were taken and coating was done with resol type phenolic resin in the similar procedure as provided in example 5. Weight loss due to acid solubility of resin coated proppants of size 12/20 and 20/40 US mesh were obtained as 5.6% and 7.2%, respectively. Crush resistance test were also conducted for the resin coated proppants as per the procedure provided in Example 2.Weight loss in terms of fine generated in wt % due to crushing of resin coated proppants of size 12/20 and 20/40 US mesh are as provided in Table 8.

TABLE 8
Results of crush resistance test

Size of proppant

| | 12/20 (US mesh) | 20/40 (US mesh) |
|---|---|---|
| Stress level | Fine generated (wt %) | Fine generated (wt %) |
| 7500 psi | 4.2 | 5.1 |
| 10000 psi | 7.4 | 5.6 |
| 12500 psi | 9.3 | 7.1 |
| 15000 psi | 12.7 | 11.1 |

### Example 8

Test were conducted to generate the comparative data for Crush Resistance Test (as per American Petroleum Institute (API) recommendation practices) between Resin Coated Sand Proppants [Calcined bauxite proppants from Australia, United States International Trade Commission (USITC), Publication, 2172, March 1989, Page A-7] and Resin Coated Bauxite Proppants of the present invention for the proppant size 20/40 (US Mesh) for high pressures i.e. 10000, 12500 and 15000 psi. Wight loss in terms of fine generated in wt % are provided in Table 9.

TABLE 9
Results of crush resistance test

| | Fine generated at different Stress levels | | |
|---|---|---|---|
| | At 10,000 psi | At 12,500 psi | At 15,000 psi |
| | [Fine generated | [Fine generated | [Fine generated |
| Proppant Sample | (wt %)] | (wt %)] | (wt %)] |
| Resin Coated Sand | 3.7 | 8.8 | 13.3 |
| Proppants | | | |
| Resin Coated Bauxite | 3.97 | 4.35 | 5.44 |
| Proppants (Present | | | |
| Invention) | | | |

It can be observed from the obtained crush resistance data that with increase in pressure from 10,000 psi to 15,000 psi, the amount of fine generation for the Resin Coated Sand Proppants increases and are considerably higher than that of the Resin Coated Bauxite Proppants of the present invention. Therefore, the Resin Coated Bauxite Proppants (Present Patent) are superior to Resin Coated Sand Proppants in respect of crush resistance and are able to withstand high pressure.

### ADVANTAGES OF THE INVENTION

The main advantages of the present invention are:
1. The present invention provides a process for coating bauxite proppants by a phenolic resin without using any curing agent and partitioning agent.
2. The present invention provides a simple method for coating proppants with a phenolic resin which enhances the mechanical strength of the proppants.
3. The present invention provides a process for coating bauxite proppants by a phenolic resin which reduces the acid solubility of the proppants, considerably.
4. The present invention provides a method of coating proppants with a phenolic resin for improved properties.

1. A process for the preparation of a resin coated proppant, said process comprising the steps of:
i. grinding raw calcined bauxite to obtain ground bauxite particles having a particle size in the range of 50 to 100 microns;
ii. pelletizing said ground bauxite particles obtained in step (i) in a pelletizing machine by adding 5 to 10% water with the ground bauxite particles and rotating the machine for a period in the range of 5 to 15 minutes to obtain pellets;
iii. sieving said pellets obtained in step (ii) to separate pellets having a size in the range of 425 to 850 microns;
iv. air drying the separated pellets obtained in step (iii) for a period in the range of 24 to 36 hours to obtain dried pellets;
v. sintering said dried pellets obtained in step (iv) at a temperature in the range of 1350 to 1450° C. for a period in the range of 30 to 35 minutes to obtain proppants;
vi. dissolving 5 to 10% of a phenol-m-cresol-formaldehyde resin in a solvent to obtain a resin solution;
vii. pouring the resin solution obtained in step (vi) on the proppants obtained in step (v) in a ratio ranging between 1:40 to 1:60 (w/w) with stirring for a period in the range of 30 to 35 minutes at a temperature in the range of 40 to 50° C. followed by drying and heating at a temperature in the range of 60 to 100° C. to obtain the resin coated proppants.

2. The process as claimed in claim 2, wherein the resin in step (vi) comprises phenol, m-cresol and formaldehyde in the molar ratio in the range of 1:1:1.5 to 1:1:2.

3. The process as claimed in claim 2, wherein the solvent is acetone.

4. A resin coated proppant prepared by the process as claimed in claim 2, said resin coated proppant comprising
resin in the amount of 1.5- 2% by weight; and
proppant in the amount of 98 to 98.5% by weight,
wherein the resin is phenol-m-cresol-formaldehyde resin and the proppant is bauzite and the resin is coated over the proppant,
wherein said resin coated proppant exhibits resistance in the range of 13.7 to 40.96% by weight against a 3% HF-12% HCI mixture and crush resistance in the range of 66.25% to 69.26% by weight against a pressure of 15000 psi.
